(19) United States
(12) Patent Application Publication
(10) Pub. No.: US 2013/0271661 A1
(43) Pub. Date: Oct. 17, 2013

(54) DISPLAY DEVICE, TELEVISION RECEIVER, CONTROL METHOD FOR DISPLAY DEVICE

(71) Applicants: Tomohiro Kimura, Osaka-shi (JP); Kohji Fujiwara, Osaka-shi (JP); Akiko Miyazaki, Osaka-shi (JP); Toshiharu Kusumoto, Osaka-shi (JP)

(72) Inventors: Tomohiro Kimura, Osaka-shi (JP); Kohji Fujiwara, Osaka-shi (JP); Akiko Miyazaki, Osaka-shi (JP); Toshiharu Kusumoto, Osaka-shi (JP)

(73) Assignee: SHARP KABUSHIKI KAISHA, Osaka-shi, Osaka (JP)

(21) Appl. No.: 13/976,145

(22) PCT Filed: Dec. 26, 2011
(86) PCT No.: PCT/JP2011/080108

§ 371 Date: Jun. 26, 2013

(30) Foreign Application Priority Data
Dec. 28, 2010 (JP) 2010-294106

(51) Int. Cl. H04N 5/445

(52) U.S. Cl. CPC H04N 5/445
USPC 348/564

(57) ABSTRACT

A display device includes a display portion having an aspect ratio of (16+a):9 on an assumption that a is a positive number and the aspect ratio represents a ratio of horizontal size:vertical size. The display device presents full display of a first image having the aspect ratio of 16:9 such that a vertical size of the first image is substantially equal to a vertical size of the display portion, while displaying a second image to be not overlapped with the first image. Convenience for users can be thereby increased.

### TECHNICAL FIELD

The present invention relates to a display device for displaying a plurality of images at the same time.

### BACKGROUND ART

When a main content image of, e.g., television (TV) broadcasting and a sub-content image, such as a program listing, are displayed at the same time, it is usual to display the sub-content image in a blank area that is generated by scaling down the main content image, or to display the main content image and the sub-content image in overlapped relation (i.e., by replacing a part of the main content image with the sub-content image).

Assume here, for example, that an aspect ratio (horizontal size:vertical size in a viewing state) of a display portion is 16:9 and the main content image is displayed in accordance with HDTV broadcasting (aspect ratio of 16:9). In such a case, when only the main content image is displayed, the main content image is displayed at the aspect ratio of 16:9 by setting the vertical size of the main content image to be matched with that of the display portion. When the main content image and the sub-content image are both displayed at the same time, the sub-content image is displayed in a blank area that is generated by resizing the main content image (i.e., by reducing the vertical size of the main content image to be smaller than that of the display portion and displaying the main content image at the aspect ratio of 16:9). Alternatively, the sub-content image is displayed in overlapped relation to a part (e.g., a peripheral end portion) of the main content image without resizing the main content image.

Patent Literature 1 discloses a technique for, when a navigation image is to be scaled up in an instrument panel configured to display the navigation image and a speed meter image at the same time, both the images are displayed by enlarging only the horizontal size of the navigation image without changing the vertical size thereof such that the speed meter image is changed to the form having a smaller horizontal size.

### CITATION LIST

### Patent Literature

PTL 1: Japanese Patent No. 4302764

### SUMMARY OF INVENTION

### Technical Problem

The above-described related art has a problem that when the sub-content image is displayed in addition to the main content image, viewing of the main content image is impeded by resizing of the main content image or overlapped display of the sub-content image. Another problem resides in that an additional load is applied to a display device because of needing a process of resizing the main content image or a process of overlapping the sub-content image.

An object of the present invention is to propose a display device that is more convenient for users.

### Solution to Problem

The present invention provides a display device including a display portion having an aspect ratio of (16+a):9 on an assumption that a is a positive number and the aspect ratio represents a ratio of horizontal size:vertical size, wherein the display device presents full display of a first image having the aspect ratio of 16:9 such that a vertical size of the first image is substantially equal to a vertical size of the display portion, while displaying a second image to be not overlapped with the first image.

The above-mentioned features can solve the problem that viewing of the first image is impeded by resizing of the first image or overlapped display of the second image.

### Advantageous Effects of Invention

According to the present invention, a display device being more convenient for users can be realized.

### BRIEF DESCRIPTION OF DRAWINGS

FIG. 1 is a schematic view illustrating a display portion of a television receiver of the present invention.

FIG. 2 is a schematic view illustrating one example of first and second images.

FIG. 3 is a schematic view illustrating a method for displaying the first image.

FIG. 4 is a schematic view illustrating a method for displaying a third image (cinema size image).

FIG. 5 is a schematic view illustrating one example of resolution in a main area MAR.

FIG. 6 is a block diagram illustrating a configuration of the television receiver of the present invention.

FIG. 7 is a schematic view illustrating one example of configuration of data signal lines and scan signal lines in the display portion.

FIG. 8 is a schematic view illustrating another example of configuration of the data signal lines and the scan signal lines in the display portion.

FIG. 9 is a schematic view illustrating respective pixel structures of the main area MAR and a sub-area SAR.

FIG. 10 is a block diagram illustrating another example of configuration of the television receiver of the present invention.

FIG. 11 is a block diagram illustrating still another example of configuration of the television receiver of the present invention.

FIG. 12 is a block diagram illustrating still another example of configuration of the television receiver of the present invention.

FIG. 13 is a schematic view to explain advantageous effects of the television receiver of the present invention.

FIG. 14 is a schematic view illustrating still another example of configuration of the television receiver of the present invention.

FIG. 15 is a schematic view illustrating still another example of configuration of the television receiver of the present invention.

### DESCRIPTION OF EMBODIMENTS

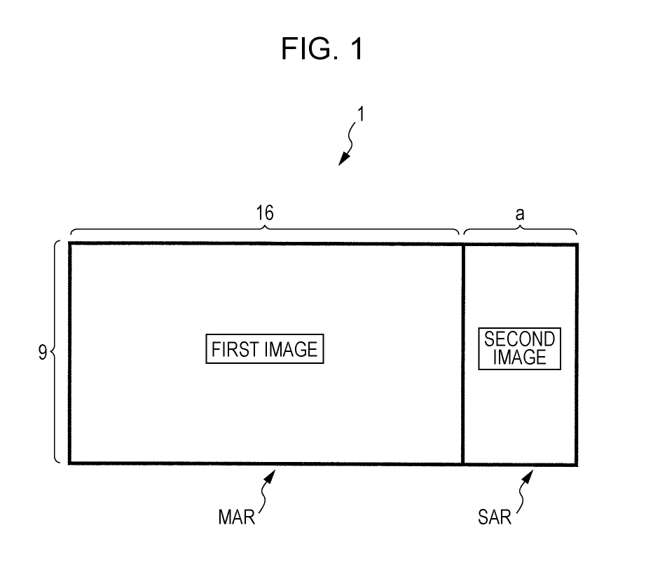

Embodiments of the present invention will be described below with reference to FIGS. 1 to 15. In the following description, it is assumed that a is a positive number, and that an aspect ratio implies a ratio of horizontal size:vertical size. Furthermore, the expression “full display” implies that an entire image is displayed without changing the aspect ratio thereof.

### EXAMPLE 1

FIG. 1 is a schematic view illustrating an arrangement of a display portion 1 of a television receiver (such as a liquid crystal television or a mobile liquid crystal display mounted in, e.g., a cellular phone) of the present invention. As illustrated in FIG. 1, the television receiver includes the display portion having the aspect ratio of (16+a):9. The television receiver presents full display of a first image having the aspect ratio of 16:9 such that a vertical size of the first image is substantially equal to a vertical size of the display portion, while displaying a second image to be not overlapped with the first image. In more detail, a main area MAR (first area) having the aspect ratio of 16:9 and a sub-area SAR (second area) having the aspect ratio of a:9 are horizontally arranged side by side in the display portion 1 in a state not overlapping with each other. The display portion 1, the main area MAR, and the sub-area SAR have respective vertical sizes substantially equal to one another. The first image is displayed in the main area MAR, and the second image is displayed in the sub-area SAR.

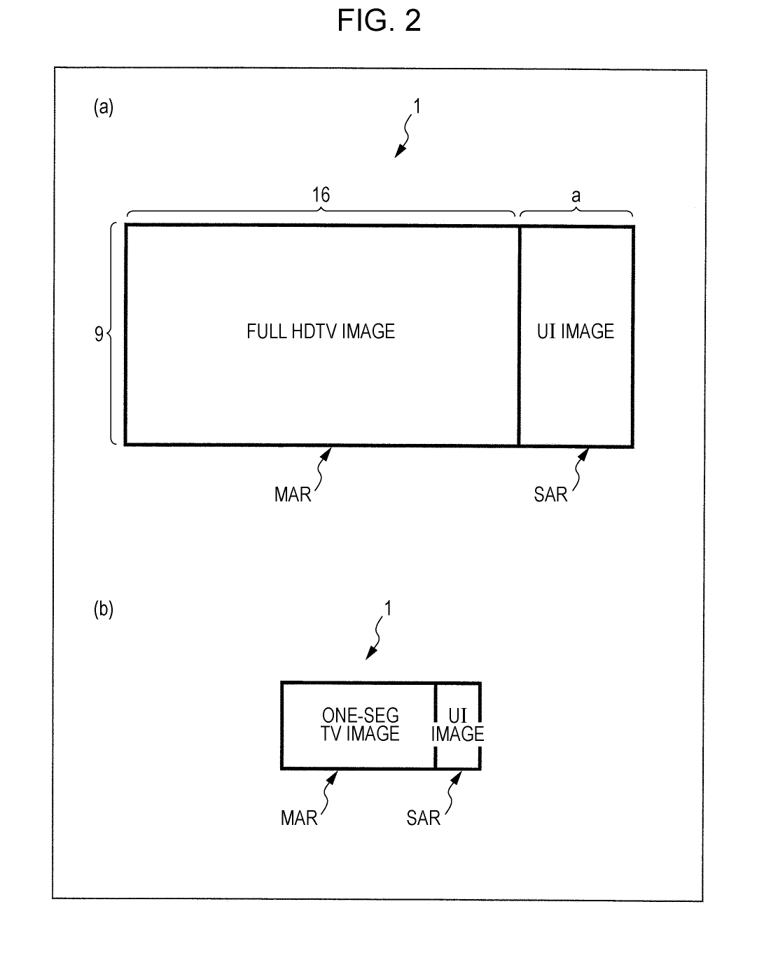

The first image displayed in the main area MAR is, for example, a full HDTV (high-definition television broadcasting, also called hi-vision broadcasting) image having the aspect ratio of 16:9, or a One Seg (one segment receiving service for mobile devices) TV image having the same aspect ratio of 16:9 (see FIGS. 2(a) and 2(b)). It is to be noted that a resolution and an image source of the first image may be optional insofar as the first image has the aspect ratio of 16:9. However, the first image is preferably an image having a resolution not lower than that of the full HDTV image.

The second image displayed in the sub-area SAR may be any image, such as a user interface (UI) image, a gazette image, an image supplied from an external network or an external device, or a television broadcasting image different from that displayed in the main area MAR. The aspect ratio, a resolution or an image source of the second image may also be optional. Furthermore, a plurality of content images may be displayed in the sub-area SAR.

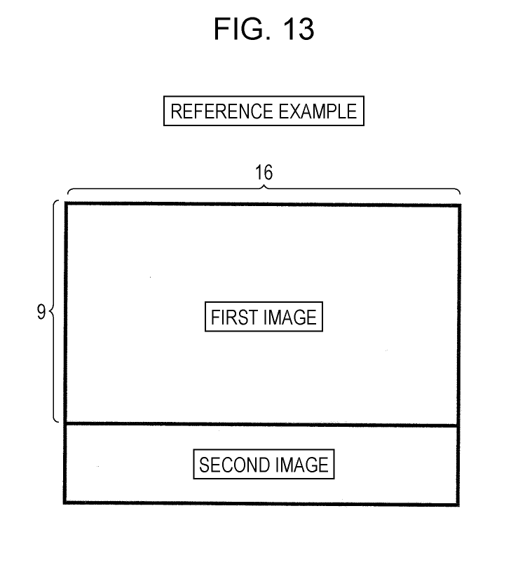

In the television receiver of the present invention, since the first image having the aspect ratio of 16:9 is presented in full display such that the vertical size of the first image is substantially equal to the vertical size of the display portion, while the second image is displayed to be not overlapped with the first image, an advantage is obtained in that viewing of the first image is not impeded by the display of the second image. Another advantage is that a load applied to the television receiver is reduced because a process of resizing the first image or a process of overlapping the second image is no longer required. Still another advantage is that the arrangement of FIG. 1 can reduce a load of a source driver for driving data signal lines in comparison with an arrangement (in which the first and second images are arranged side by side in the vertical direction) of FIG. 13 that is a reference drawing.

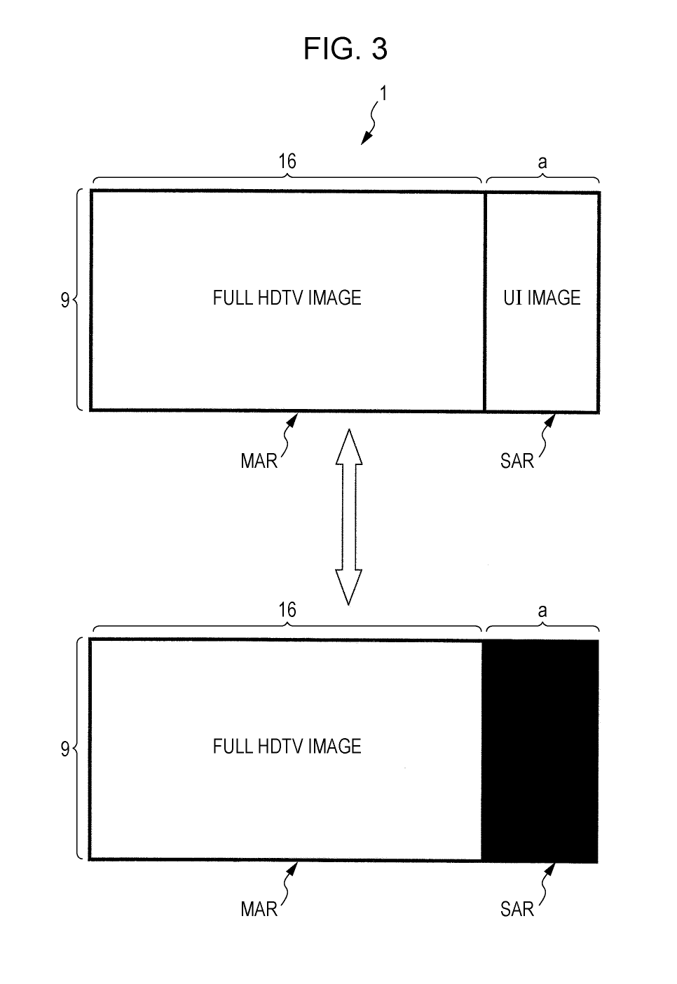

In the television receiver, as illustrated in FIG. 3, the first image is displayed in the main area MAR with its display size kept fixed regardless of whether or not the second image is displayed.

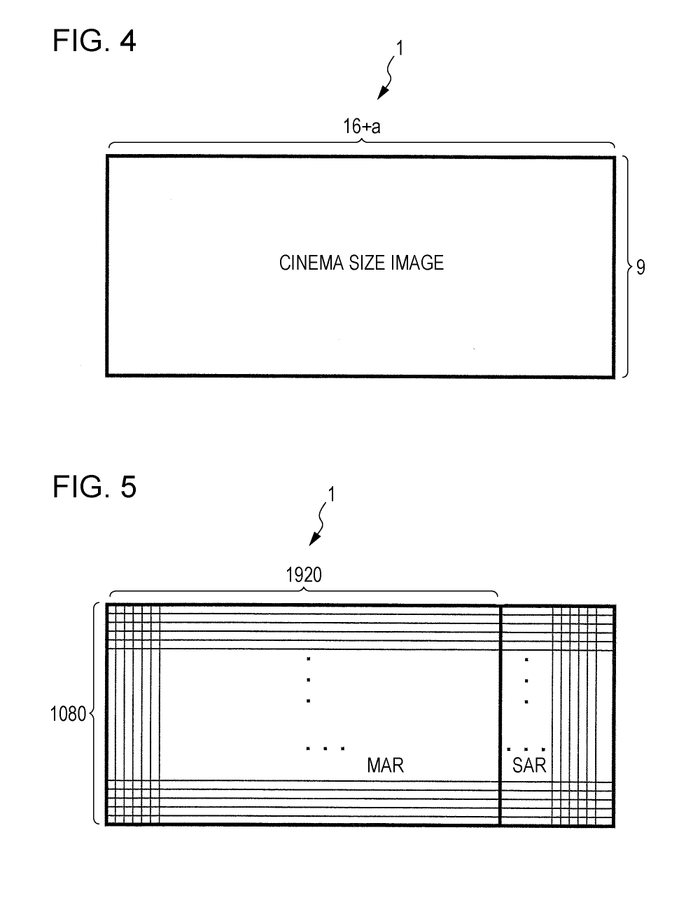

Moreover, in the television receiver, a third image having the aspect ratio of (16+a):9 is presented in full display in the entire display portion (i.e., the main area MAR+the sub-area SAR) such that a vertical size of the third image is substantially equal to the vertical size of the display portion 1 (see FIG. 4). The third image is, for example, a cinema size image having the aspect ratio of 21:9. In consideration of such a case, the above-mentioned positive number a is preferably set to a=5.

In the television receiver, since the image having a resolution not lower than that of the full HDTV image is displayed as it is in the main area MAR, a resolution in the main area MAR is desirably set to be not lower than that defined by 1080 (number of scan signal lines) in the vertical direction×1920 in the horizontal direction, as illustrated in FIG. 5. The sub-area SAR may have the same resolution as that in the main area MAR or a lower resolution than that in the main area MAR. In each of the main area MAR and the sub-area SAR, scan signal lines extend in the horizontal direction, and data signal lines extend in the vertical direction.

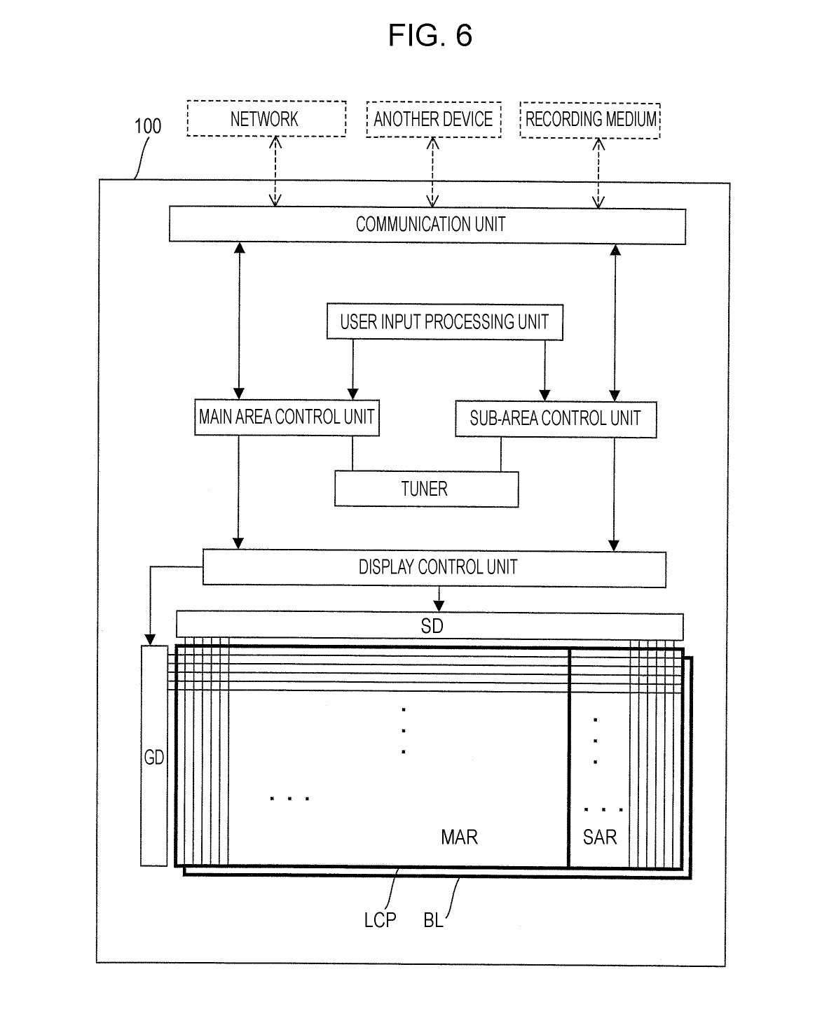

FIG. 6 is a block diagram illustrating a configuration of a television receiver 100 of the present invention. As illustrated in FIG. 6, the television receiver 100 includes a liquid crystal panel LCP constituting the display portion 1, a backlight BL, a source driver SD, a gate driver GD, a display control unit, a sub-area control unit, a main area control unit, a user input processing unit, a tuner, and a communication unit.

The source driver SD drives data signal lines of the liquid crystal panel LCP, and the gate driver GD drives scan signal lines of the liquid crystal panel LCP. The tuner receives television broadcasting.

The user input processing unit processes a user input and outputs a processing result to the main area control unit and the sub-area control unit. The main area control unit outputs image data for the main area to the display control unit, the image data corresponding to the processing result of the user input processing unit. The sub-area control unit outputs image data for the sub-area to the display control unit, the image data corresponding to the processing result of the user input processing unit.

The display control unit includes a timing controller. The display control unit receives the image data for the main area and the image data for the sub-area and controls a liquid crystal panel drive circuit including the gate driver GD and the source driver SD.

For example, when a user inputs an instruction of displaying an HDTV image under broadcasting in the main area MAR, the main area control unit having received the processing result from the user input processing unit takes in corresponding HDTV image data through the tuner and outputs the taken-in data to the display control unit.

As another example, when a user inputs an instruction of displaying an HDTV image, recorded on a recording medium (e.g., a hard disk), in the main area MAR, the main area control unit having received the processing result from the user input processing unit takes in HDTV image data, recorded on the recording medium, through the communication unit and outputs the taken-in data to the display control unit.

As still another example, when a user inputs an instruction of displaying an HDTV image residing on a network in the main area MAR, the main area control unit having received the processing result from the user input processing unit takes in HDTV image data on the network through the communication unit and outputs the taken-in data to the display control unit.

As still another example, when a user inputs an instruction of displaying an HDTV image, captured by a video camera (another device), in the main area MAR, the main area control unit having received the processing result from the user input processing unit takes in HDTV image data, captured by the video camera, through the communication unit and outputs the taken-in data to the display control unit.

As still another example, when a user inputs an instruction of displaying a Twitter image in the sub-area SAR, the sub-area control unit having received the processing result from the user input processing unit takes in Twitter image data on the network through the communication unit and outputs the taken-in data to the display control unit.

As still another example, when a user inputs an instruction of displaying a TV telephone image in the sub-area SAR, the sub-area control unit having received the processing result from the user input processing unit takes in TV telephone image data from a TV telephone line through the communication unit and outputs the taken-in data to the display control unit.

As still another example, when a user inputs an instruction of displaying an HDTV image under broadcasting in the sub-area SAR, the sub-area control unit having received the processing result from the user input processing unit takes in corresponding HDTV image data through the tuner and outputs the taken-in data to the display control unit.

### EXAMPLE 2

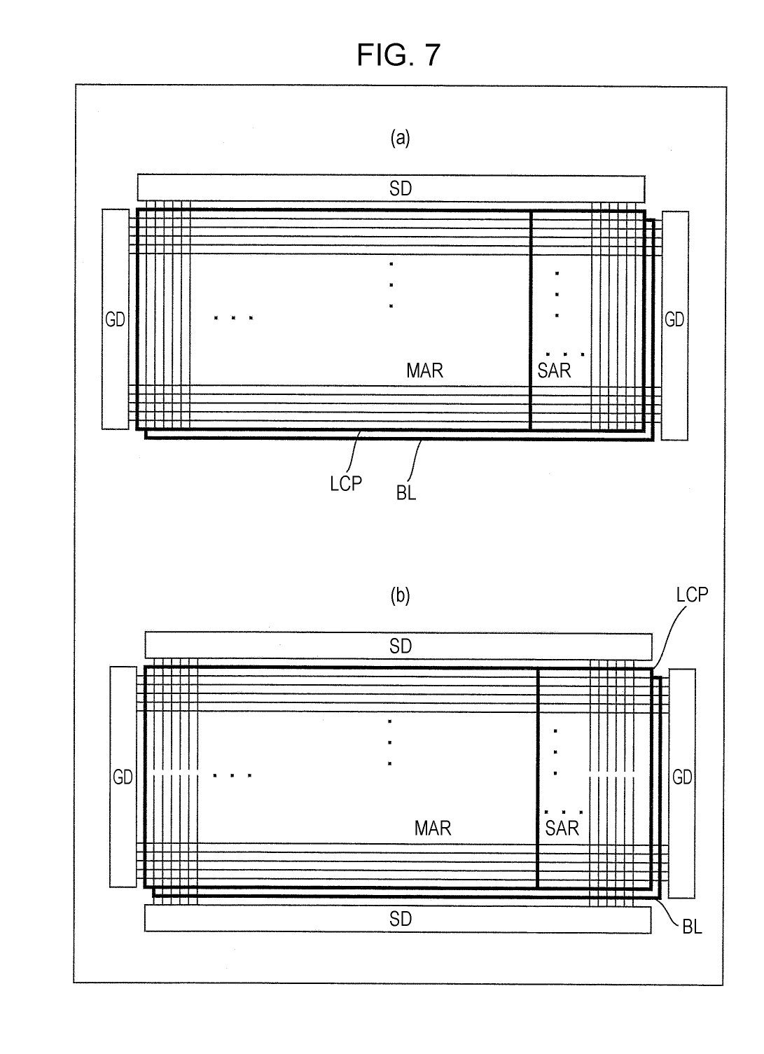

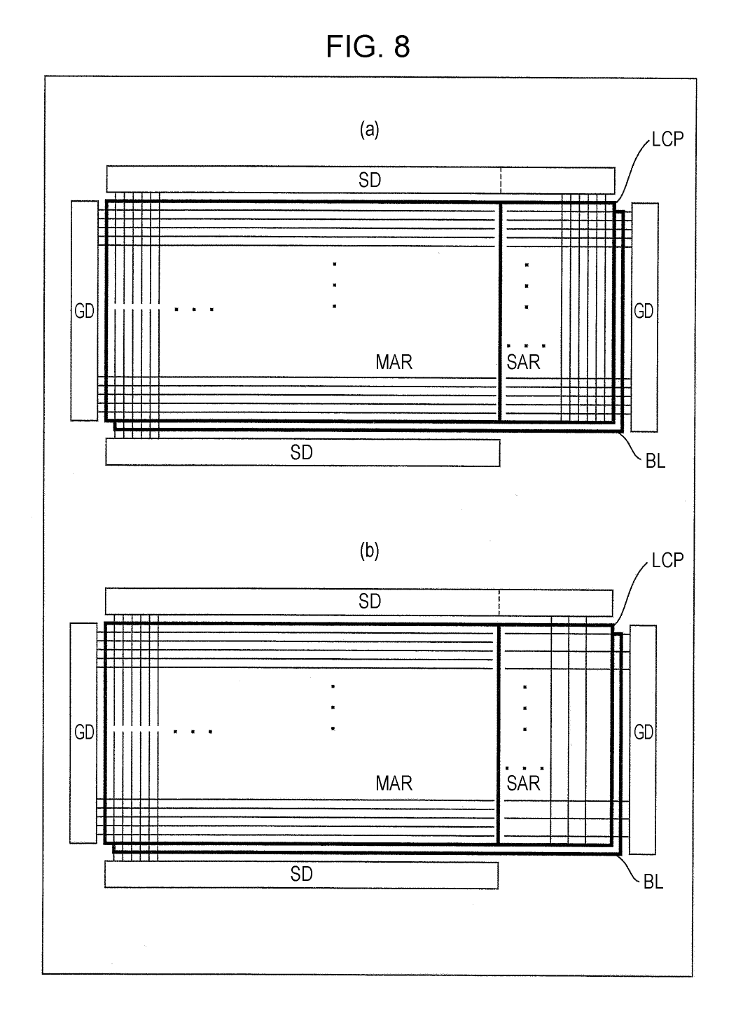

The data signal lines and the scan signal lines of the liquid crystal panel LCP may be arranged as follows. For example, as illustrated in FIG. 7(a), the main area MAR and the sub-area SAR may be constituted in the same structure, and the scan signal lines may be connected at both sides thereof to the gate drivers GD (so-called gate both-side located arrangement). As another example, as illustrated in FIG. 7(b), in addition to constituting the main area MAR and the sub-area SAR in the same structure and connecting the scan signal lines at both sides thereof to the gate drivers GD, the data signal lines may be divided into groups corresponding to an upper half and a lower half of the display portion and the divided scan signal line groups may be driven separately (so-called source both-side located arrangement). As still another example, as illustrated in FIG. 8(a), the scan signal lines may be divided into groups corresponding to the main area MAR and the sub-area SAR and the divided scan signal line groups may be driven separately. As still another example, as illustrated in FIG. 8(b), the arrangement of FIG. 8(a) may be modified such that a resolution in the sub-area SAR (i.e., respective total numbers of the scan signal lines and the data signal lines in the sub-area SAR) is lower than a resolution in the main area MAR (i.e., respective total numbers of the scan signal lines and the data signal lines in the sub-area SAR).

### EXAMPLE 3

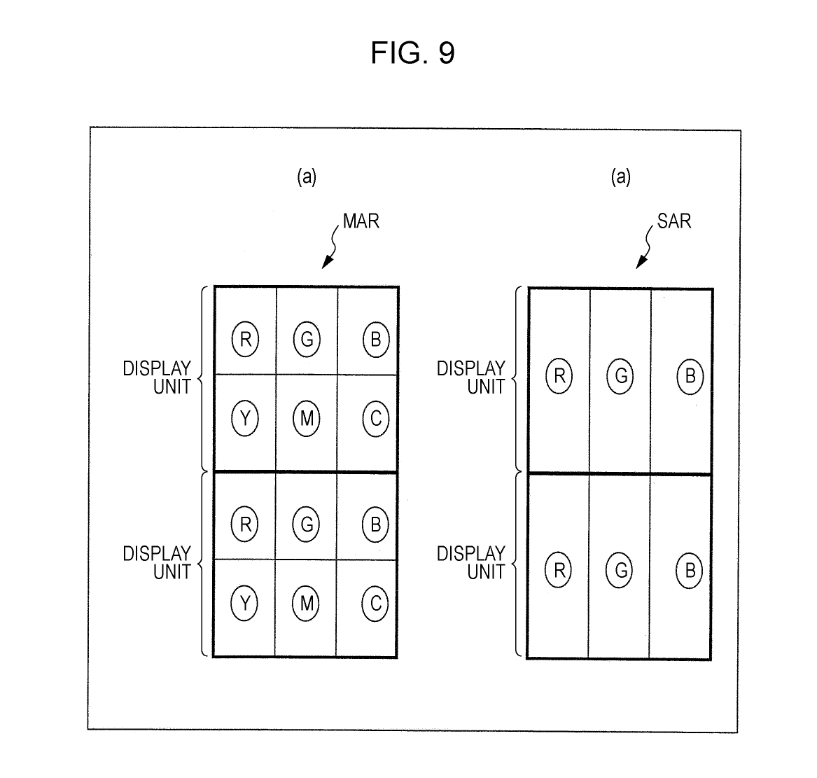

As illustrated in FIGS. 9(a) and 9(b), the pixel arrangement in the liquid crystal panel LCP (display portion 1) may be set such that a minimum display unit has different arrangements between the main area MAR and the sub-area SAR. More specifically, in the main area MAR, the displaying unit is constituted by six pixels of R, G, B, Y, M and C. On the other hand, in the sub-area SAR, the displaying unit is constituted by three pixels of R, G and B.

### EXAMPLE 4

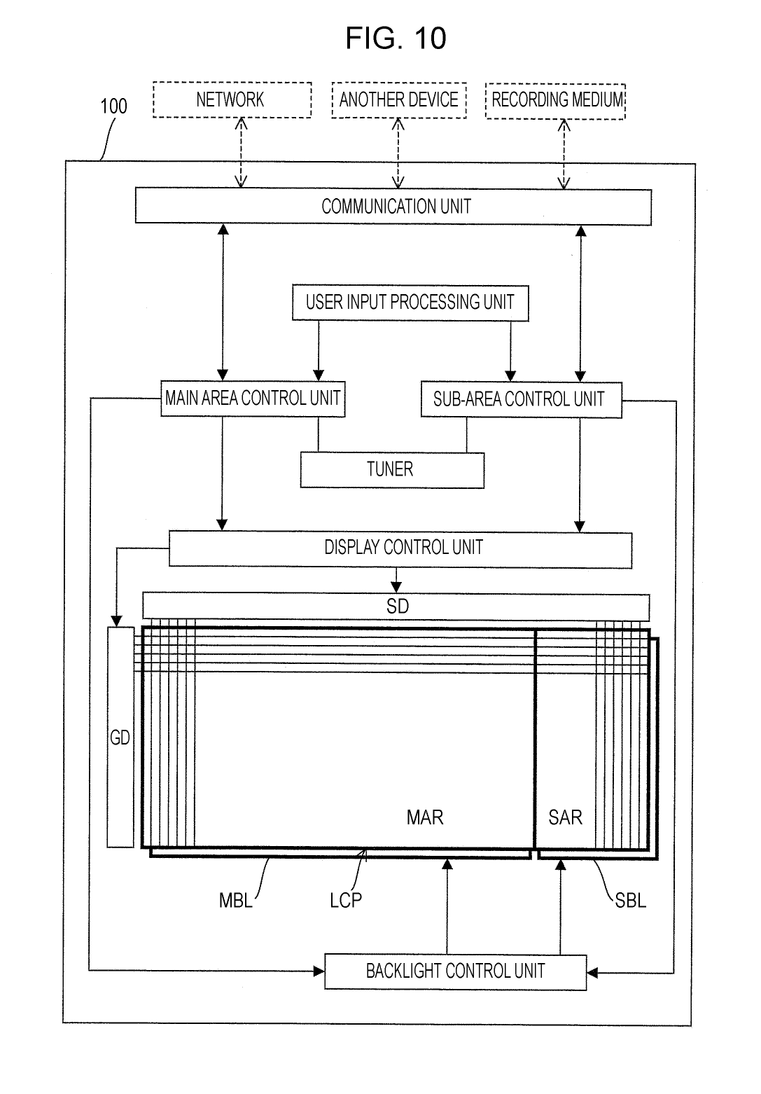

Furthermore, as illustrated in FIG. 10, the television receiver 100 of the present invention may include a first backlight MBL corresponding to the main area MAR, a second backlight SBL corresponding to the sub-area SAR, and a backlight control unit for separately controlling the first and second backlights. More specifically, in the first backlight MBL, (plural) LED elements, including LED's in three colors of R, G and B, are arranged in a matrix pattern. The plural LED elements (e.g., a set of four LED elements of 2 in the vertical direction×2 in the horizontal direction) are constituted as one set, and the individual LED elements are subjected to brightness control per set (so-called 2D type brightness control). In the second backlight SBL, (plural) LED elements, including LED's in three colors of R, G and B, are arranged in a matrix pattern. The LED elements (in the second backlight) are all subjected to brightness control in the same manner (so-called 0D type brightness control).

By combining the configuration of FIG. 10 with the arrangement of FIG. 8 (i.e., the arrangement for separately driving a portion corresponding to the main area of the liquid crystal panel and a portion corresponding to the sub-area of the liquid crystal panel), it is also possible to display an image only in the sub-area SAR (namely, to keep the main area MAR turned OFF). Alternatively, it is further possible to display an image only in the main area MAR (namely, to keep the sub-area SAR turned OFF).

### EXAMPLE 5

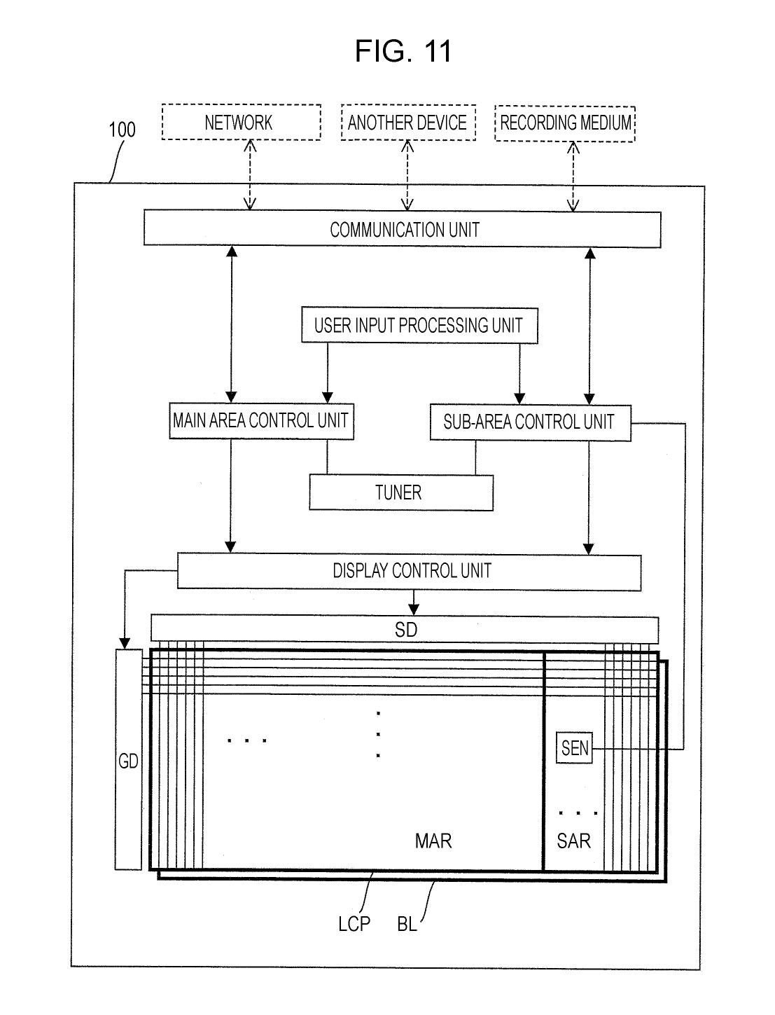

As illustrated in FIG. 11, the television receiver of the present invention may further include a sub-area sensor in the sub-area SAR. The sub-area sensor has the function of receiving a user input and the function of measuring environment (e.g., an amount of external light and/or temperature), and it is controlled by the sub-area control unit. The provision of the sub-area sensor enables the user to enter an input with touching or approaching to the sub-area surface of the display portion 1, thereby increasing convenience for users.

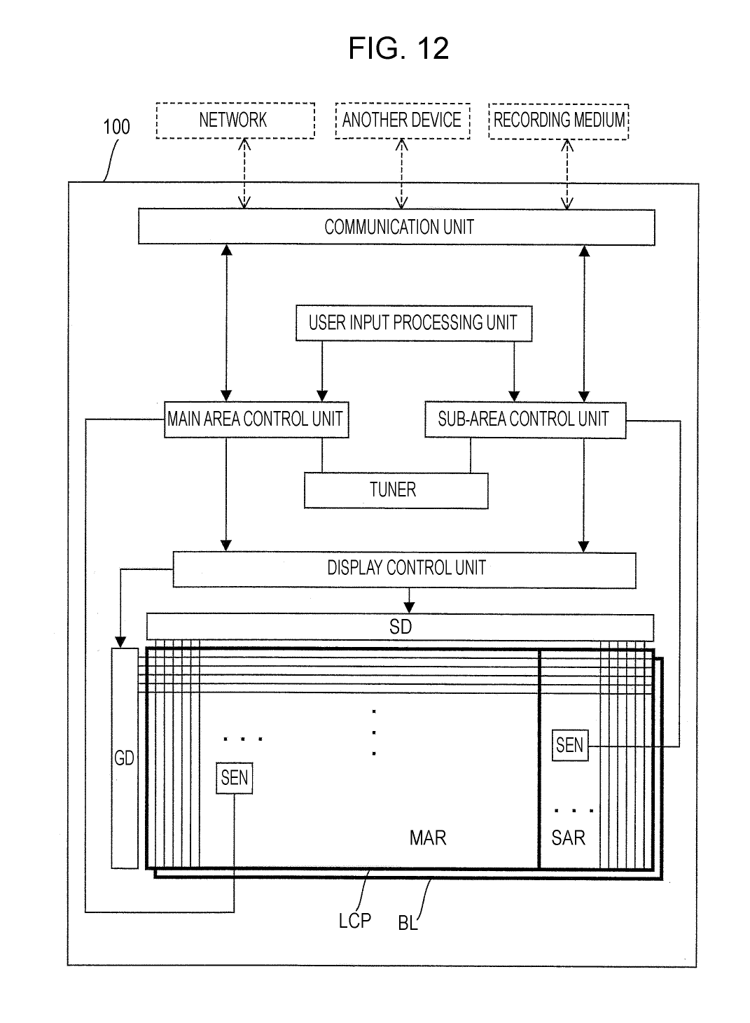

In the television receiver of the present invention, as illustrated in FIG. 12, a main area sensor may be disposed in the main area MAR, and a sub-area sensor may be disposed in the sub-area SAR. The main area sensor has the function of receiving a user input and the function of measuring environment (e.g., an amount of external light and/or temperature), and it is controlled by the main area control unit. On the other hand, the sub-area sensor has the function of receiving a user input and the function of measuring environment (e.g., an amount of external light and/or temperature), and it is controlled by the sub-area control unit. In the configuration of FIG. 12, the sub-area sensor and the main area sensor may be different from each other in sensitivity (control method), the function, or structure.

A display device of the present invention includes a display portion having an aspect ratio of (16+a):9 on an assumption that a is a positive number and the aspect ratio represents a ratio of horizontal size:vertical size, and presents full display of a first image having the aspect ratio of 16:9 such that a vertical size of the first image is substantially equal to a vertical size of the display portion, while displaying a second image to be not overlapped with the first image.

With the above-described feature, it is possible to solve the problem that viewing of the first image is impeded by resizing of the first image or overlapped display of the second image.

In the display device, a display size of the first image may be set fixed regardless of whether or not the second image is displayed.

In the display device, the first image may be displayed such that one of vertical edges of the first image is aligned with one of vertical edges of the display portion.

In the display device, the first image may have a resolution not lower than that of high-definition television (HDTV) broadcasting.

In the display device, a third image having the aspect ratio of (16+a):9 may be presented in full display such that a vertical size of the third image is substantially equal to the vertical size of the display portion.

In the display device, a=5 may be set.

In the display device, the first image may be an image of high-definition television (HDTV) broadcasting, or an image of One Seg broadcasting.

In the display device, the scan signal lines may extend in the horizontal direction, and the data signal lines may extend in the vertical direction.

In the display device, the second image may include a plurality of content images.

In the display device, the second image may be a user interface image.

In the display device, the display portion may include a first area having the aspect ratio of 16:9 and a second area having the aspect ratio of a:9 and not overlapping with the first area. The display portion and the first and second areas may have equal vertical sizes. The first image may be displayed in the first area, and the second image may be displayed in the second area.

In the display device, a pixel structure may be different between the first area and the second area.

In the display device, a driving method may be different between the first area and the second area.

The display device may further include a first sensor disposed in the first area and a second sensor disposed in the second area, the first and second sensor being separately controlled.

In the display device, the display portion may be constituted by a liquid crystal panel.

The display device may further include a first backlight corresponding to the first area and a second backlight corresponding to the second area, the first and second backlights being separately controlled.

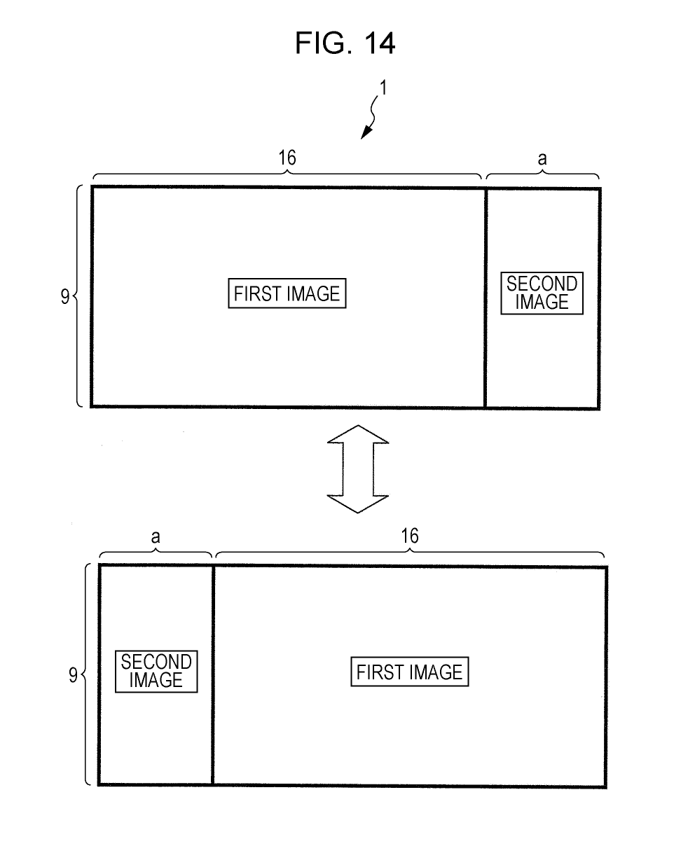

In the display device, a horizontal display position of the first image and a horizontal display position of the second image may be set in accordance with a user's instruction (for example, as illustrated in FIG. 14, display positions may be changed in accordance with a user's instruction such that the first image is displayed on the right side and the second image is displayed on the left side, or that the first image is displayed on the left side and the second image is displayed on the right side).

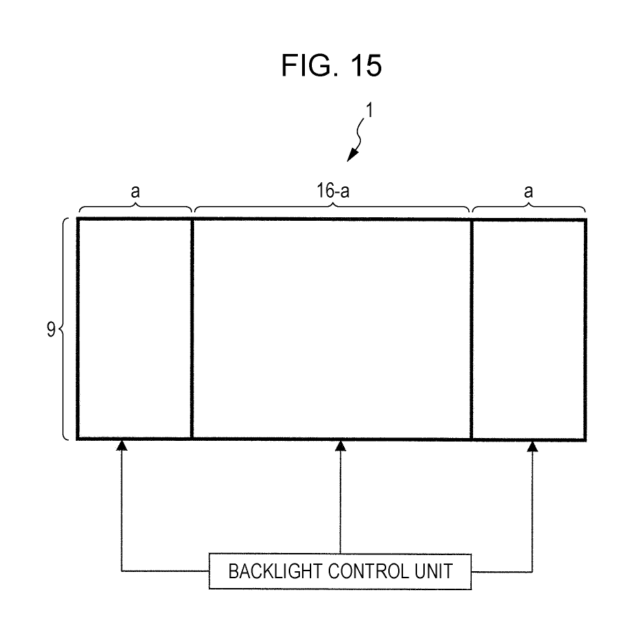

In such a case, as illustrated in FIG. 15, on an assumption that the display portion 1 is horizontally divided into (16+a) equal parts, that an area corresponding to a number a of parts from the left edge is called a left end area, that an area corresponding to a number a of parts from the right edge is called a right end area, and that an area corresponding to a number (16−a) of remaining parts is called a central area, the backlight control unit may be constituted to separately control a portion of the backlight corresponding to the left end area, a portion of the backlight corresponding to the right end area, and a portion of the backlight corresponding to the central area. With that feature, brightness of the backlight can be changed between the area corresponding to the first image and the area corresponding to the second image in such a way that power consumption can be reduced.

The television receiver of the present invention includes the display device described above.

In a control method for a display device, according to the present invention, the display device including a display portion having an aspect ratio of (16+a):9 on an assumption that a is a positive number and the aspect ratio represents a ratio of horizontal size:vertical size, full display of a first image having the aspect ratio of 16:9 is presented such that a vertical size of the first image is substantially equal to a vertical size of the display portion, while a second image is displayed to be not overlapped with the first image.

It is to be noted that the present invention is not limited to the above-described embodiments, and that modifications obtained by modifying the above-described embodiments as required on the basis of technical common knowledge and combinations of those modifications are also involved in the scope of embodiments of the present invention.

### INDUSTRIAL APPLICABILITY

The display device of the present invention is suitably applied to a television receiver, for example.

### REFERENCE SIGNS LIST

1 display portion

MAR main area

SAR sub-area

LCP liquid crystal panel

BL backlight

SD source driver

GD gate driver

SEN sensor for user input

1. A display device including a display portion having an aspect ratio of (16+a):9 on an assumption that a is a positive number and the aspect ratio represents a ratio of horizontal size:vertical size,
wherein the display device presents full display of a first image having the aspect ratio of 16:9 such that a vertical size of the first image is substantially equal to a vertical size of the display portion, while displaying a second image to be not overlapped with the first image.

2. The display device according to claim 1, wherein a display size of the first image is set fixed regardless of whether or not the second image is displayed.

3. The display device according to claim 1 or 2, wherein the first image is displayed such that one of vertical edges of the first image is aligned with one of vertical edges of the display portion.

4. The display device according to claim 1, wherein the first image has a resolution not lower than that of high-definition television (HDTV) broadcasting.

5. The display device according to claim 1, wherein a third image having the aspect ratio of (16+a):9 is presented in full display such that a vertical size of the third image is substantially equal to the vertical size of the display portion.

6. The display device according to claim 1, wherein a=5 is set.

7. The display device according to claim 1, wherein the first image is an image of high-definition television (HDTV) broadcasting, or an image of One Seg broadcasting.

8. The display device according to claim 1, wherein scan signal lines extend in a horizontal direction, and data signal lines extend in a vertical direction.

9. The display device according to claim 1, wherein the second image includes a plurality of content images.

10. The display device according to any one of claim 1, wherein the second image is a user interface image.

11. The display device wherein the display portion includes a first area having the aspect ratio of 16:9 and a second area having the aspect ratio of a:9 and not overlapping with the first area,
the display portion and the first and second areas have equal vertical sizes, and
the first image is displayed in the first area, and the second image is displayed in the second area.

12. The display device according to claim 11, wherein a pixel structure is different between the first area and the second area.

13. The display device according to claim 11, wherein a driving method is different between the first area and the second area.

14. The display device according to claim 11, further including a sensor for a user input in the second area.

15. The display device according to claim 1, further including a first sensor disposed in the first area and a second sensor disposed in the second area,
the first and second sensor being separately controlled.

16. The display device according to claim 1, wherein the display portion is constituted by a liquid crystal panel.

17. The display device according to claim 16, further including a first backlight corresponding to the first area and a second backlight corresponding to the second area,
the first and second backlights being separately controlled.

18. The display device according to claim 1, wherein a horizontal display position of the first image and a horizontal display position of the second image are set in accordance with a user's instruction.

19. A television receiver including the display device according to claim 1.

20. A control method for a display device including a display portion having an aspect ratio of (16+a):9 on an assumption that a is a positive number and the aspect ratio represents a ratio of horizontal size:vertical size,
wherein full display of a first image having the aspect ratio of 16:9 is presented such that a vertical size of the first image is substantially equal to a vertical size of the display portion, while a second image is displayed to be not overlapped with the first image.
